(19) United States
(12) Patent Application Publication
(10) Pub. No.: US 2012/0003442 A1
(43) Pub. Date: Jan. 5, 2012

(54) DECORATION FILM

(75) Inventor: Chun-Hsu Lin, Taichung City (TW)

(73) Assignee: SIPIX CHEMICAL INC., Taoyuan County (TW)

(21) Appl. No.: 12/829,358

(22) Filed: Jul. 1, 2010

(51) Int. Cl. B32B 3/10; B32B 5/16

(52) U.S. Cl. 428/206; 428/195.1; 428/209

(57) ABSTRACT

A decoration film including a substrate, a releasing layer, at least an alignment mark and a pattern layer is provided. A substrate has a surface. The releasing layer is disposed on the surface of the substrate. The alignment mark is disposed on the surface of the substrate or a side of the releasing layer far from the substrate. The pattern layer is disposed on the releasing layer at a side far from the substrate in the correspondence with the alignment mark.

### BACKGROUND OF THE INVENTION

1. Field of the Invention

The present invention generally relates to a decoration film, in particular, to a decoration film having a substrate with at least an alignment mark.

2. Description of Related Art

Conventionally, the illustrations or decorations formed on the surface of the plastic housing are mainly fabricated by spraying process or printing process to present certain visual effect. Nevertheless, the spraying process is unfavorable in mass production for the disadvantages of time consumption and process complexity. In addition, the conventional spraying process may cause the splashing of sprays containing lead or other heavy metals so that the spraying material is wasted and the problem of pollution is caused. Furthermore, during the spraying process, the mass of the coating material is not easily controlled so that the thickness is usually uneven. Particularly, when the spraying process is performed on the curve portion of the housing, the improper accumulation of the coating material is worse.

To solve the abovementioned problem, an in-mold roller (IMR) technique is provided. The process of the IMR technique includes placing a film has predetermined decorations into the mold of the injection machine, injecting a melted resin at a side of the film in the mold so that the melted resin and the film are combined to form a decorated housing, and thereafter ejecting the decorated housing from the mold. Accordingly, the in-mold roller process is completed.

### SUMMARY OF THE INVENTION

The invention directs to a decoration film having a substrate with at least an alignment mark in order to increase the alignment accuracy between the layers relatively.

The invention provides a decoration film including a substrate, a releasing layer, at least an alignment mark and a pattern layer is provided. A substrate has a surface. The releasing layer is disposed on the surface of the substrate. The alignment mark is disposed on the surface of the substrate or a side of the releasing layer far from the substrate. The pattern layer is disposed on the releasing layer at a side far from the substrate in the correspondence with the alignment mark.

In an embodiment of the invention, a matte layer is disposed between the substrate and the releasing layer, wherein the matte layer includes a plurality of particles therein, the distribution of the particles defines a low gloss surface, and the releasing layer is conformed to the low gloss surface so as to have a rough surface.

In an embodiment of the invention, a material of the matte layer is selected from the group consisting of polyurethane, polymethylmethacrylate, epoxide, and polyester.

In an embodiment of the invention, an average particle diameter of the particles is between 0.1 μm and 30 μm.

In an embodiment of the invention, a material of the particles is selected from the group consisting of silicon dioxide, calcium carbonate, calcium sulfate, barium sulfate, aluminum oxide and titanium oxide.

In an embodiment of the invention, the particles are hollow spheres, non-film-forming latexes or dispersions.

In an embodiment of the invention, the matte layer completely covers the substrate.

In an embodiment of the invention, the matte layer exposes a portion of the substrate.

In an embodiment of the invention, the releasing layer has a bumpy surface located at a side far from the substrate and a flat surface located at a side adjacent to the substrate, and the flat surface and the bumpy surface are opposite to each other.

In an embodiment of the invention, the decoration film further includes a shielding layer disposed on a portion of the low gloss surface in correspondence with the alignment mark, wherein the shielding layer is located between the releasing layer and the matte layer, and a portion of the releasing layer corresponding to the shielding layer has a flat surface structure.

In an embodiment of the invention, the decoration film includes a protective layer disposed between the pattern layer and the releasing layer.

In an embodiment of the invention, the decoration film further includes a metal layer disposed on the protective layer and being coplanar to the pattern layer.

In an embodiment of the invention, a material of the protective layer is selected from the group consisting of radiation curable multifunctional acrylates, epoxide, vinyl ester resins, diallyo(o-) phthalate, vinyl ether and combinations thereof.

In an embodiment of the invention, the radiation curable multifunctional acrylates includes epoxy acrylates, polyurethane acrylates, polyester acrylates, silicone acrylates, glycidyl acrylates, epoxides, vinyl esters, diallyl phthalate, vinyl ethers and blends thereof.

In an embodiment of the invention, the decoration film further includes a metal layer disposed on the pattern layer, wherein the metal layer is conformed to the pattern layer.

In an embodiment of the invention, the decoration film further includes an adhesion layer disposed on the pattern layer and being exposed.

In an embodiment of the invention, the substrate has a pattern structure, and the releasing layer is conformed to the pattern structure so as to have a bumpy surface.

In an embodiment of the invention, a material of the substrate is selected from the group consisting of polyethylene terephthalate (PET), polyethylene naphthalate

(PEN), polyethylene glycol-co-cyclohexane-1,4 dimethanol terephthalate (PETG), thermalplastic polyurethane (TPU), polyurethane (PU), polypropylene (PP), polycarbonate (PC), amorphous polyethylene terephthalate (A-PET), polyvinyl chloride (PVC), Polystyrene (PS), triacetyl cellulose (TAC), polymethylmethacrylate (PMMA), methylmethacrylate-styrene (MMA-st, MS) copolymer,cyclo olefin copolymer (COC) and combinations thereof.

In an embodiment of the invention, the alignment mark includes an icon, a symbol, a letter, a figure or combinations thereof.

In an embodiment of the invention, the decoration film further includes at least a sub-alignment mark, disposed on the surface of the substrate, the side of the releasing layer far from the substrate, the matte layer, the metal layer, the protective layer or the pattern layer.

In view of the above, since the substrate of the decoration film in the present invention has the alignment mark, the alignment accuracy between the layers, such as the pattern layer, the shielding layer, the matte layer, the metal layer and so forth, can increase relatively.

In order to make the aforementioned and other features and advantages of the invention more comprehensible, embodiments accompanying figures are described in detail below.

Herein, the same or similar reference numbers used in the drawings and the descriptions are referred as the same or similar elements. For clearly describing the concept of the invention, the shapes and the thickness of the elements in the embodiments accompanying with the drawings may not definitely comply with the real circumstance. In addition, the following descriptions are directed to the elements or the combinations thereof, but the elements are not particularly restricted in the contents or the descriptions. Any form or shape known by one skilled in the art is applicable in the invention. Moreover, the description that a material layer disposed on a substrate or disposed on another material layer means that the material layer is directly located on the substrate or another material layer, and may also mean that some interlayer is interrupted between the material layer and the substrate or between the material layer and another material layer.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic cross-sectional view of a decoration film according to one embodiment of the present invention.

FIG. 1B is a schematic cross-sectional view of the decoration film in FIG. 1A in which the releasing layer is removed form the protective layer.

FIG. 1C is a schematic cross-sectional view of a decoration film according to another embodiment of the present invention.

FIG. 1D is a schematic cross-sectional view of a decoration film according to still another embodiment of the present invention.

FIG. 2 is a schematic cross-sectional view of a decoration film according to still another embodiment of the present invention.

FIG. 3 is a schematic cross-sectional view of a decoration film according to still another embodiment of the present invention.

FIG. 4A is a schematic cross-sectional view of a decoration film according to still another embodiment of the present invention.

FIG. 4B is a schematic cross-sectional view of the decoration film in FIG. 4A in which the releasing layer is removed form the matte layer.

FIG. 5A is a schematic cross-sectional view of a decoration film according to still another embodiment of the present invention.

FIG. 5B is a schematic cross-sectional view of a decoration film according to still another embodiment of the present invention.

FIG. 6 is a schematic cross-sectional view of a decoration film according to still another embodiment of the present invention.

FIG. 7 is a schematic cross-sectional view of a decoration film according to still another embodiment of the present invention.

FIG. 8 is a schematic cross-sectional view of a decoration film according to still another embodiment of the present invention.

FIG. 9 is a schematic cross-sectional view of a decoration film according to still another embodiment of the present invention.

FIG. 10 is a schematic cross-sectional view of a decoration film according to still another embodiment of the present invention.

FIG. 11 is a flow chart of a method for manufacturing a decoration device according to one embodiment of the present invention.

### DESCRIPTION OF THE EMBODIMENTS

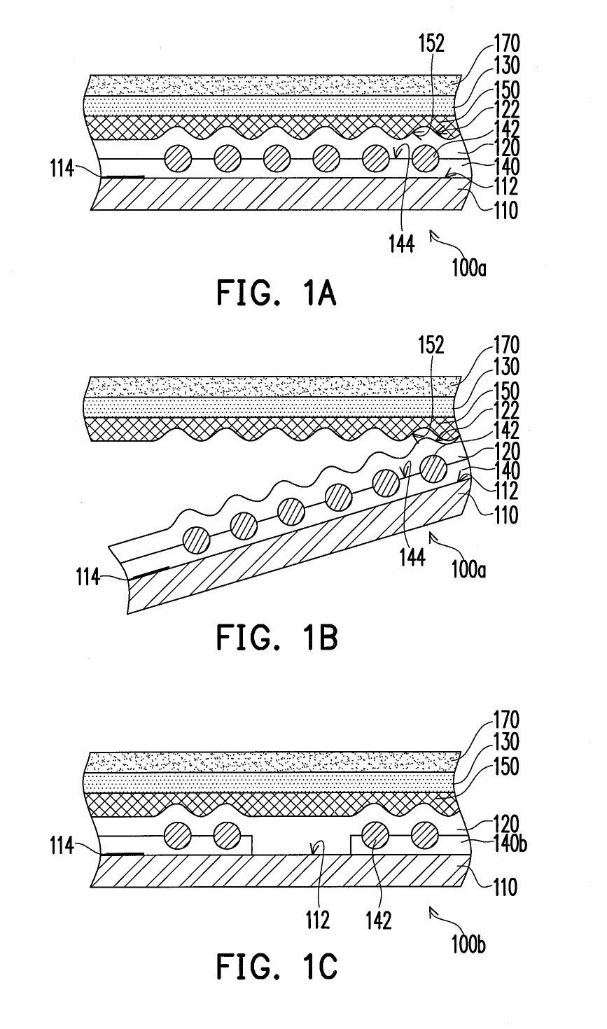

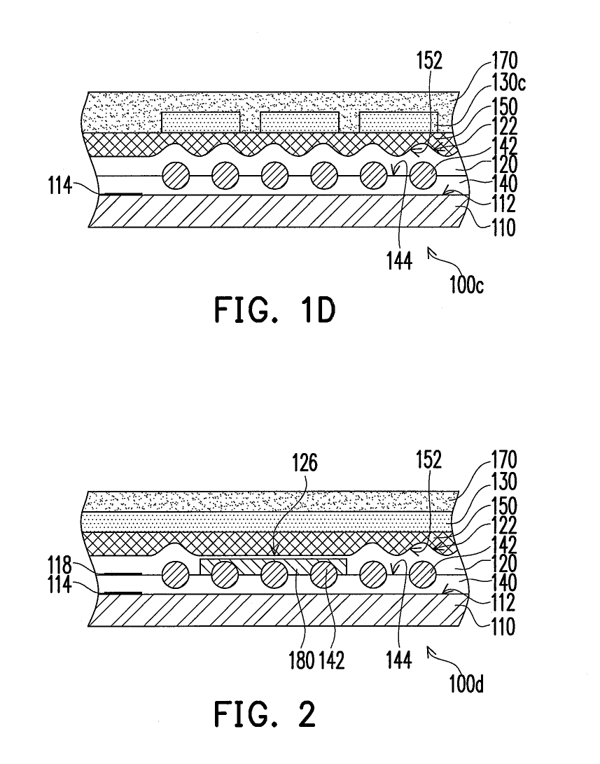

FIG. 1A is a schematic cross-sectional view of a decoration film according to one embodiment of the present invention. FIG. 1B is a schematic cross-sectional view of the decoration film in FIG. 1A in which the releasing layer is removed from the protective layer. Firstly, referring to FIG. 1A, a decoration film 100a including a substrate 110, a releasing layer 120, at least an alignment mark 114 and a pattern layer 130 is provided. In more detail, the substrate 110 has a surface 112. The alignment mark 114 is disposed on the surface 112 of the substrate 110, and the alignment mark 114 can be an icon, a symbol, a letter, a figure or combinations thereof, for example. The releasing layer 120 is disposed on the surface 112 of the substrate 110. The pattern layer 130 is disposed on the releasing layer 130 at a side far from the substrate 110 in the correspondence with the alignment mark 114.

It should be noted that although the above-mentioned alignment mark 114 disposed on the surface 112 of the substrate 110, but in other embodiments, the alignment mark 114 can be disposed on a side of the releasing layer 120 far from the substrate 110, which the present invention is not limited to. Certainly, in other embodiment, the decoration film 100a further includes at least a sub-alignment mark (not shown), wherein the sub-alignment mark can be disposed on the surface 112 of the substrate 110, the side of the releasing layer 120 far from the substrate 110 or the pattern layer 130 for second alignment, which the present invention is not limited to.

Specifically, the decoration film 100a of the present embodiment further includes a matte layer 140 and a protective layer 150. Herein, the matte layer 140 is disposed between the substrate 110 and the releasing layer 120, and the matte layer 140 completely covers the substrate 110. The matte layer 140 of the present embodiment includes a plurality of particles 142 therein, and the distribution of the particles 142 defines a low gloss surface 144. The releasing layer 120 is conformed to the low gloss surface 144 so as to have a rough surface 122. The protective layer 150 is disposed between the pattern layer 130 and the releasing layer 120, wherein a side of the protective layer 150 adjacent to the releasing layer 120 has a rough surface 152 due to the low gloss surface 144 of the matte layer 140.

In addition, a material of the substrate 110 can be polyethylene terephthalate (PET), polyethylene naphthalate (PEN), polyethylene glycol-co-cyclohexane-1,4 dimethanol terephthalate (PETG), thermalplastic polyurethane (TPU), polyurethane (PU), polypropylene (PP), polycarbonate (PC), amorphous polyethylene terephthalate (A-PET), polyvinyl chloride (PVC), Polystyrene (PS), triacetyl cellulose (TAC), polymethylmethacrylate (PMMA), methylmethacrylate-styrene (MMA-st, MS) copolymer,cyclo olefin copolymer (COC) and a combination thereof, but the invention is not restricted herein. It is noted that the substrate 110 is flexible for facilitating the subsequent process.

The releasing layer 120 of the present embodiment is configured for temporally adhering the protective layer 150 and the matte layer 140 in order to facilitate lifting off the matte layer 140 and the protective layer 150 after the transfer process by applying a release force, as shown in FIG. 1B. Accordingly, the releasing layer 120 is usually a thin film with low surface tension which can be made of a wax, a paraffin, or silicone, or an impermeable thin film with high smoothness which can be made of an irradiation curable multi-functional acrylic, silicone acrylate, epoxy, vinyl, allyl vinyl compound, unsaturated polyester or a mixture thereof. A material of the releasing layer 120 can be selected from a polycondensate, a copolymer, a blend, or a mixture consisting of epoxy, polyurethane, polyimide, polyamide, hexa methoxymethyl melamine-formaldehyde, urea-formaldehyde, phenol-formaldehyde, and a combination thereof.

The pattern layer 130 can be made of any ink or printable material by the printing. A method of forming the pattern layer 130 of the present embodiment may be carried out by any printing techniques, such as flexographic, driographic, electro photographic or lithographic printing. Other printing techniques, such as stamping, screen printing, gravure printing, ink jet printing or thermal printing may also be suitable.

In the present embodiment, a material of the matte layer 140 is selected from the group consisting of polyurethane (PU), polymethylmethacrylate (PMMA), epoxide, polyester and combinations thereof. A material of the particles 142 is selected from the group consisting of silicon dioxide, calcium carbonate, calcium sulfate, barium sulfate, aluminum oxide and titanium oxide. The particles 142 may be made of a metal powder, an organic pigment or an inorganic pigment. In addition, the particles 142 are hollow spheres, non-film-forming latexes or dispersions, for example. An average particle diameter of the particles 142 is, between 0.1 μm and 30 μm, perfectly, is between 1 μm and 15 μm.

Furthermore, suitable raw materials for the protective layer 150 may include, but are not limited to, radiation curable multifunctional acrylates including epoxy acrylates, polyurethane acrylates, polyester acrylates, silicone acrylates, glycidyl acrylates, epoxides, vinyl esters, diallyl phthalate, vinyl ethers and blends thereof. The protective layer 150 may comprise a condensation polymer or copolymer, such as epoxy, polyurethane, polyamide, polyimide, melamine formaldehyde, urea formaldehyde or phenol formaldehyde. The protective layer 150 may comprise a sol-gel silicate or titanium ester.

The protective layer 150 may be partially or fully cured. If partially cured, a post curing step will be employed after the molding and/or transferring step to enhance the durability, particularly hardness, scratch and oil resistance. In addition, to improve the release properties, the raw material, particularly the low molecular weight components of the protective layer 150 is preferably not permeable into the releasing layer 120. After the protective layer 150 is coated and cured or partially cured, it should be marginally compatible or incompatible with the releasing layer 120. Binders and additives such as thickeners, surfactants, dispersants, UV stabilizers or antioxidants may be used to control the rheology, wettability, coating properties, weatherability and aging properties. Fillers such as silica, Al.sub.2O.sub.3, TiO.sub.2, CaCO.sub.3, microcrystalline wax or polyethylene, Teflon or other lubricating particles may also be added to improve, for example, scratch resistance and hardness of the protective layer 150. The protective layer 150 is usually about 2 to about 20 microns, preferably about 3 to about 12 microns in thickness. The protective layer 150, if present, is preferably transparent in a window area.

In addition to the materials described above, other suitable compositions for the optional protective layer 150 are disclosed in U.S. 2005-0181204, U.S. 2005-0171292, and U.S. 2006-0093813, the contents of all of which are incorporated herein by reference in their entirely. For example, U.S. 2005-0181204 discloses a protective layer 150 composition which comprises a thermally crosslinkable and photochemically or radically graftable polymer, a thermal crosslinker and a radiation curable multifunctional monomer or oligomer; U.S. 2005-0171292 discloses a protective layer 150 composition which comprises a polymer or copolymer having at least one carboxylic acid or acid anhydride functionality for thermal crosslinking and at least one

UV crosslinkable functionality; and U.S. 2006-0093813 discloses a protective layer 150 composition which comprises an amino crosslinker, a UV curable monomer or oligomer having at least one functional group reactive with the amino crosslinker, an acid catalyst; and a photoinitiator.

Moreover, the decoration film 100a further includes an adhesion layer 170 which is disposed on the pattern layer 130 and being exposed. The adhesion layer 170 can be made of polyacrylate, polymethacrylate, polystyrene, polycarbonate, polyurethane, polyester, polyamide, epoxy resin, ethylene vinyl acetate (EVA), thermoplastic elastomer, the like, a copolymer thereof, a blend thereof, or a mixture thereof. In the present embodiment, the adhesion layer 170 is configured for facilitating the subsequent process so that the decoration film 100a in other embodiments may not have the disposition of the adhesion layer 170.

It should be noted that although the above-mentioned matte layer 140 completely covers the substrate 110, but in other embodiment, as shown in FIG. 1C, the matte layer 140b of the decoration film 100b can be a patterned matte layer and dispose on a portion of the substrate 110 in correspondence with the alignment mark 114. Namely, the matte layer 140b exposes a portion of the surface 112 of the substrate 110, which the present invention is not limited to.

In addition, although the above-mentioned pattern layer 130 completely disposed on the protective layer 150, but in other embodiment, as shown in FIG. 1D, the pattern layer 130c of the decoration film 100c can expose a portion of the protective layer 150, wherein the pattern layer 130c is disposed on a portion of the protective layer 150 in correspondence with the alignment mark 114, which the present invention is not limited to.

In brief, since the substrate 110 of the decoration film 100a has the alignment mark 114, the alignment accuracy between the layers, such as the pattern layer 130 (or 130c) and matte layer 140 (or 140b), can increase relatively. Furthermore, alignment mark 114 is formed on the surface 112 of the substrate 110 by printing process, such as stamping, screen printing, gravure printing, ink jet printing and so forth, as compared with the conventional substrate which has the through hole design, the available space of the substrate 110 in the present embodiment is saved, and the fabrication thereof is simple.

FIG. 2 is a schematic cross-sectional view of a decoration film according to still another embodiment of the present invention. Referring to FIGS. 1A and 2, the decoration film 100d in FIG. 2 is similar to the decoration film 100a in FIG. 1A except that the decoration film 100d in FIG. 2 further includes a shielding layer 180 and a sub-alignment mark 118.

In more detail, the sub-alignment mark 118 is disposed on the low gloss surface 144 of the metal layer 140, and the sub-alignment mark 118 can be an icon, a symbol, a letter, a figure or combinations thereof; for example. The shielding layer 180 is disposed on a portion of the low gloss surface 144 in correspondence with the sub-alignment mark 118, wherein the shielding layer 180 is located between the releasing layer 120 and the matte layer 140, and a portion of the releasing layer 120 corresponding to the shielding layer 180 has a flat surface structure 126. In other words, the shielding layer 180 is disposed on the portion of the low gloss surface 144 in correspondence with the sub-alignment mark 118, and the metal layer 140 is disposed between the substrate 110 in correspondence with the alignment mark 114. In addition, a material of the shielding layer 180 can be polyurethane (PU), polymethylmethacrylate (PMMA), epoxide or polyester, but the invention is not restricted herein.

Since the decoration film 100d of the present embodiment has the shielding layer 180 disposed between the releasing layer 120 and the matte layer 140, opposing surfaces of the protective layer 150 and the shielding layer 180 are formed substantially flat, and thus a partial fuzzy effect is obtained.

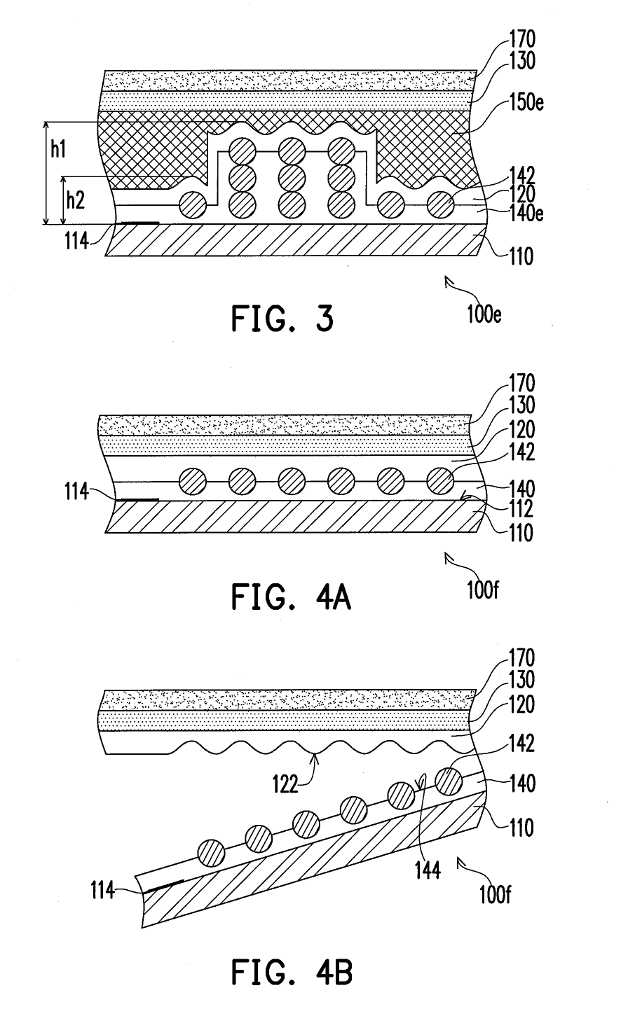

FIG. 3 is a schematic cross-sectional view of a decoration film according to still another embodiment of the present invention. Referring to FIGS. 1A and 3, the decoration film 100e in FIG. 3 is similar to the decoration film 100a in FIG. 1A except that the matte layer 140e of the decoration film 100e in FIG. 3 has at least two thicknesses. In more detail, the matte layer 140e has a first thickness h1 and a second thickness h2, wherein the first thickness h1 is greater than the second thickness h2. Since the matte layer 140e of the present embodiment has different thickness, a side surface of the protective layer 150e in correspondence with the matte layer 140e has different depths. Thereby, the surface of the protective layer 150e can provide different light-shift directions after removing the releasing layer 120 by applying a release force so as to obtain the light gradient effect.

FIG. 4A is a schematic cross-sectional view of a decoration film according to still another embodiment of the present invention. Referring to FIGS. 1A and 4A, the decoration film 100f in FIG. 4 is similar to the decoration film 100a in FIG. 1A except that the decoration film 100f in FIG. 4A has no protective layer. In more detail, the pattern layer 130 is directly disposed on the releasing layer 120, and the releasing layer 120 is disposed at a side of the matte layer 140. After the transfer, the matte layer 140 is removed from the releasing layer 120 by applying a release force, as shown in FIG. 4B, and the bumpy surface 122 of the releasing layer 120 in correspondence with the low gloss surface 144 of the matte layer 140 is exposed. Therefore, the bumpy surface 122 of the releasing layer 120 can provide different light-shift directions so as to obtain the light gradient effect.

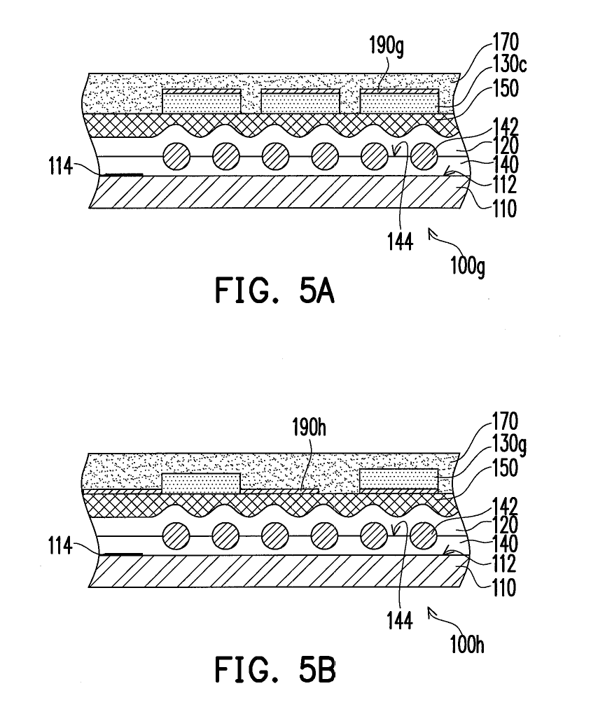

FIG. 5A is a schematic cross-sectional view of a decoration film according to still another embodiment of the present invention. Referring to FIGS. 1D and 5A, the decoration film 100g in FIG. 5A is similar to the decoration film 100c in FIG. 1D except that the decoration film 100g in FIG. 5A further includes a metal layer 190g, and a portion or whole the particles 142 may have at least a special color.

In more detail, in the present embodiment, the particles 142 with the special color can have a better identity use as at least a sub-alignment mark for alignment to increase the alignment accuracy in the follow-up layer. For example, the metal layer 190g is disposed on the pattern layer 130c in correspondence with the sub-alignment mark (i.e, particles 142 with the special color). Namely, the pattern layer 130c is disposed on a portion of the protective layer 150 in correspondence with the alignment mark 114, and the metal layer 190g is disposed on the pattern layer 130c in correspondence with the sub-alignment mark. Certainly, in other embodiments, a portion or whole the particles 142 may also have at least a special pattern forming by the screen printing or gravure printing for at least a sub-alignment mark, which the present invention is not limited to. In addition, the metal layer 190g is conformed to the pattern layer 130, but is not limited to. In the other embodiment, the metal layer 190h may be disposed on the protective layer 150 and being coplanar to a portion of the pattern layer 130g, as show in FIG. 5B. In addition, a material of the metal layer 190g (or 190h) can be aluminum, copper, zinc, tin, molybdenum, nickel, chromium, silver, gold, iron, indium, thallium, titanium, tantalum, wolfram, rhodium, palladium, magnesium, platinum or combinations thereof. The material of the metal layer may also be ITO, IZO, AZO, Gd2O3, SnO2, FZO or the other suitable material, for example, but the invention is not restricted herein. Since the decoration films 100g, 100h of the present embodiments have the metallic luster due to the disposing of the metal layers 190g, 190h.

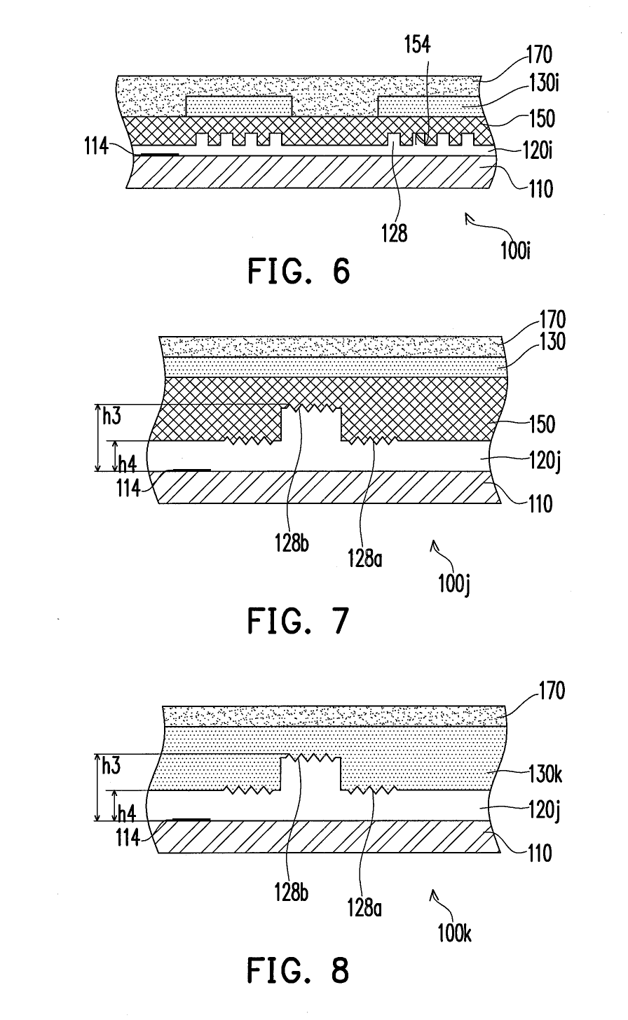

FIG. 6 is a schematic cross-sectional view of a decoration film according to still another embodiment of the present invention. Referring to FIG. 6, a decoration film 100i in the present embodiment including a substrate 110, a releasing layer 120i, a pattern layer 130i, a protective layer 150 and an adhesion layer 170. In more detail, the releasing layer 120i, the protective layer 150, the pattern layer 130i and the adhesion layer 170 are sequentially formed on the substrate 110. The releasing layer 120i has a plurality of microstructure patterns 128, wherein the microstructure patterns 128 are formed at the side of the releasing layer 120i far from the substrate 110 in correspondence with the alignment mark 114, and the microstructure patterns 128 define a bumpy surface. In addition, the releasing layer 120i has a flat surface located at a side of the releasing layer 120i adjacent to the substrate 110, and the flat surface and the bumpy surface are opposite to each other. A side of the protective layer 150 is conformed to the microstructure patterns 128 so as to have a bumpy surface 154. The pattern layer 130i is disposed on the protective layer 150 in correspondence with the microstructure patterns 128 according to the alignment mark 114. After the transfer, the releasing layer 120i is removed from the protective layer 150 by applying a release force, and the bumpy surface 154 of the protective layer 150 is exposed and provides users with a tactile feeling distinct from that provided by the conventional smooth surface.

FIG. 7 is a schematic cross-sectional view of a decoration film according to still another embodiment of the present invention. Referring to FIGS. 6 and 7, the decoration film 100j in FIG. 7 is similar to the decoration film 100i in FIG. 6 except that the releasing layer 120j of the decoration film 100j in FIG. 7 has a first bumpy surface structure 128a and a second bumpy surface structure 128b. In more detail, a height h3 of the second bumpy surface structure 128b is greater than a height h4 of the first bumpy surface structure 128a. Since the releasing layer 120j of the present embodiment has different bumpy surface structure with different height, a side surface of the protective layer 150 in correspondence with the releasing layer 120j has different depths. Thereby, the surface of the protective layer 150 can provide different light-shift directions after removing the releasing layer 120j by applying a release force so as to obtain the light gradient effect.

FIG. 8 is a schematic cross-sectional view of a decoration film according to still another embodiment of the present invention. Referring to FIGS. 7 and 8, the decoration film 100k in FIG. 8 is similar to the decoration film 100j in FIG. 7 except that the decoration film 100k in FIG. 8 has no protective layer. In more detail, the pattern layer 130k of the present embodiment is directly disposed on the releasing layer 120j, so that a side surface of the pattern layer 130k in correspondence with the releasing layer 120j has different depths. After the transfer, the releasing layer 120j is removed from the pattern layer 130k by applying a release force, and a bumpy surface of the pattern layer 130k in correspondence with the bumpy surface structure of the releasing layer 120j is exposed. Therefore, the bumpy surface of the pattern layer 130k can provide different light-shift directions so as to obtain the light gradient effect.

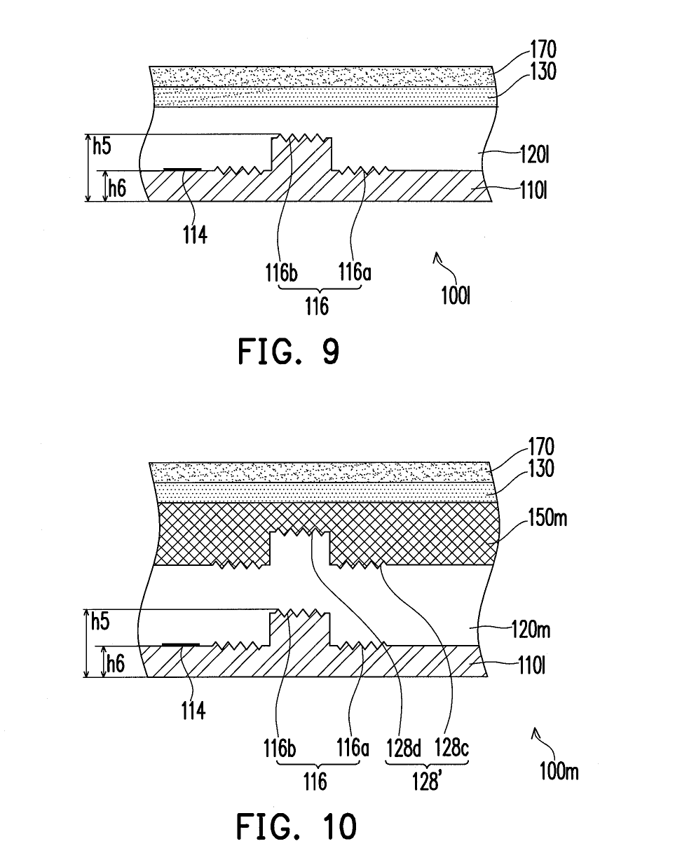

FIG. 9 is a schematic cross-sectional view of a decoration film according to still another embodiment of the present invention. Referring to FIG. 9, a decoration film 100I of the present embodiment including a substrate 110I, a releasing layer 120I, a pattern layer 130 and an adhesion layer 170 is provided. The substrate 110I has a pattern structure 116, and the pattern structure 116 includes a first pattern structure 116a and a second pattern structure 116b. Herein, a height h5 of the second pattern structure 116b is greater than a height h6 of the first pattern structure 116a. The releasing layer 1201 is conformed to the pattern structure 116 so as to have a bumpy surface. Therefore, the bumpy surface of the releasing layer 120I can provide different light-shift directions after removing the substrate 110I by applying a release force so as to obtain the light gradient effect and the better visual effect.

FIG. 10 is a schematic cross-sectional view of a decoration film according to still another embodiment of the present invention. Referring to FIGS. 9 and 10, a decoration film 100m in FIG. 10 is similar to the decoration film 100I in FIG. 9 except that the decoration film 100m in FIG. 10 has a protective layer 150m conformed to the releasing layer 120m. In more detail, the releasing layer 120m is conformed to the substrate 110I, and the releasing layer 120m has a bumpy surface structure 128′. Herein, the bumpy surface structure 128′ includes a first bumpy surface structure 128c and a second bumpy surface structure 128d. The first bumpy surface structure 128c and the second bumpy surface structure 128d are located at a side far form the substrate 110I, and a height of the second bumpy surface structure 128d is greater than a height of the first bumpy surface 128c. The first bumpy surface structure 128c and the second bumpy surface structure 128d are corresponding to the first pattern structure 116a and the second pattern structure 116b of the substrate 100I, respectively. Therefore, a side of the protective layer 150m in correspondence with the bumpy surface structure 128′ of the releasing layer 120m can provide different light-shift directions after removing the substrate 110I and the releasing layer 120m thereon by applying a release force so as to obtain the light gradient effect and the better visual effect.

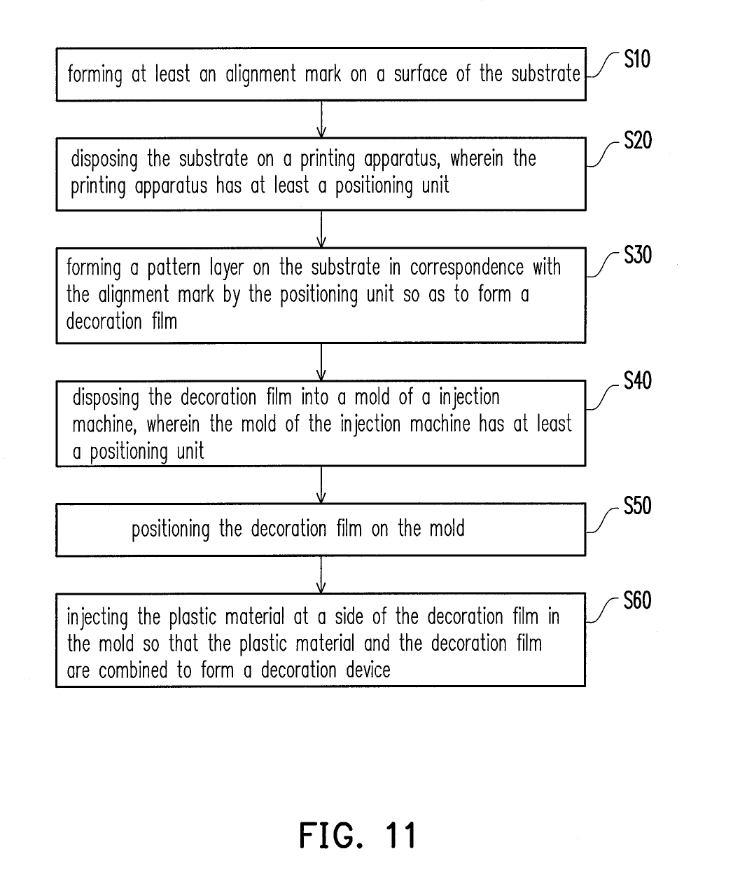

In the aforementioned descriptions, only the decoration film 100a˜100m are introduced, and a manufacturing method thereof is not mentioned. Therefore, one embodiments is provide below for describing the manufacturing method of the decoration film and the decoration film used in body to form the decoration device is described in detail with reference of FIG. 11.

FIG. 11 is a flow chart of a method for manufacturing a decoration device according to one embodiment of the present invention. Referring to FIGS. 1A and 11, according to the manufacturing method of the decoration film 100a (or 100b˜100m) of the present embodiment, first, at least one alignment mark 114 is formed on the surface 112 of the substrate 110, step 10. Herein, a method of forming the alignment mark 114 can be a printing process, such as stamping, screen printing, gravure printing, ink jet printing and so forth.

Nest, the substrate 110 is disposed on a printing apparatus, wherein the printing apparatus has at least a positioning unit, at step 20.

Next, the pattern layer 130 is formed on the substrate 110 in correspondence with the alignment mark 114 by the positioning unit, step 30. It should be noted the matte layer 140, the releasing layer 120, the protective layer 150 and the shielding layer 180 can be optionally formed on the substrate 110 before forming the pattern layer 130 according to actual requirements by the user, which the present embodiment is not limited to. In addition, at least one sub-alignment mark 118 is formed on the releasing layer 120, the matte layer 140 or the protective layer 150.

Next, the adhesion layer 170 is formed on the pattern layer 130, wherein the adhesion layer 170 is exposed and covers the pattern layer 130. Noted that, the protective layer 150 and the metal layer 190g (or 190h) can be optionally formed between the pattern layer 130 and the adhesion layer 170 before forming the adhesion layer 170. Specifically, the releasing layer 120, the matte layer 140 and the protective layer 150 can be formed on the substrate 110 in correspondence with the alignment mark 114, and the pattern layer 130, the shielding layer 180 or the metal layer 190g (or metal layer 190h) can be formed between the releasing layer 120 and the adhesion layer 170 in correspondence with the sub-alignment mark 118 so as to increase the alignment accuracy between the layers relatively. Now, manufacturing of the decoration film 100a (or 100b˜100m) is completed.

Next, the decoration film 100a (or 100b˜100m) is disposed into a mold of an injection machine, wherein the mold of the injection machine has at least a positioning unit, step 40.

Then, the decoration film 100a (or 100b˜100m) is positioned on the mold, step s50. Finally, a plastic material is injected at a side of the decoration film 100a (or 100b˜100m) in the mold, so that the plastic material and the decoration film 100a (or 100b˜100m) are combined to form a decoration device, step 60. Now, manufacturing of the decoration device with better visual effect is completed.

In summary, since the substrate of the decoration film has the alignment mark and the sub-alignment mark as first and second alignment, respectively, the alignment accuracy between the layers, such as the pattern layer, the shielding layer, the matte layer, the metal layer and so forth, can increase relatively. Furthermore, alignment mark is formed on the surface of the substrate by printing process, as compared with the conventional substrate which has the through hole design, the available space of the substrate in the present invention is saved, and the fabrication thereof is simple.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A decoration film, comprising:
a substrate having a surface;
a releasing layer disposed on the surface of the substrate;
at least an alignment mark, disposed on the surface of the substrate or a side of the releasing layer far from the substrate; and
a pattern layer disposed on the releasing layer at a side far from the substrate in correspondence with the alignment mark.

2. The decoration film as claimed in claim 1, further comprising a matte layer disposed between the substrate and the releasing layer, wherein the matte layer includes a plurality of particles therein, the distribution of the particles defines a low gloss surface, and the releasing layer is conformed to the low gloss surface so as to have a rough surface.

3. The decoration film as claimed in claim 2, wherein a material of the matte layer is selected from the group consisting of polyurethane, polymethylmethacrylate, epoxide, and polyester.

4. The decoration film as claimed in claim 2, wherein an average particle diameter of the particles is between 0.1 μm and 30 μm.

5. The decoration film as claimed in claim 2, wherein a material of the particles is selected from the group consisting of silicon dioxide, calcium carbonate, calcium sulfate, barium sulfate, aluminum oxide and titanium oxide.

6. The decoration film as claimed in claim 2, wherein the particles are hollow spheres, non-film-forming latexes or dispersions.

7. The decoration film as claimed in claim 2, wherein the matte layer completely covers the substrate.

8. The decoration film as claimed in claim 2, wherein the matte layer exposes a portion of the substrate.

9. The decoration film as claimed in claim 2, further comprising a shielding layer disposed on a portion of the low gloss surface in correspondence with the alignment mark, wherein the shielding layer is located between the releasing layer and the matte layer, and a portion of the releasing layer corresponding to the shielding layer has a flat surface structure.

10. The decoration film as claimed in claim 1, wherein the releasing layer has a bumpy surface located at a side far from the substrate and a flat surface located at another side adjacent to the substrate, and the flat surface and the bumpy surface are opposite to each other.

11. The decoration film as claimed in claim 1, further comprising a protective layer disposed between the pattern layer and the releasing layer.

12. The decoration film as claimed in claim 11, further comprising a metal layer disposed on the protective layer and being coplanar to the pattern layer.

13. The decoration film as claimed in claim 11, wherein a material of the protective layer is selected from the group consisting of radiation curable multifunctional acrylates, epoxide, vinyl ester resins, diallyo(o-) phthalate, vinyl ether and combinations thereof.

14. The decoration film as claimed in claim 13, wherein the radiation curable multifunctional acrylates includes epoxy acrylates, polyurethane acrylates, polyester acrylates, silicone acrylates, glycidyl acrylates, epoxides, vinyl esters, diallyl phthalate, vinyl ethers and blends thereof.

15. The decoration film as claimed in claim 1, further comprising a metal layer disposed on the pattern layer, wherein the metal layer is conformed to the pattern layer.

16. The decoration film as claimed in claim 1, further comprising an adhesion layer disposed on the pattern layer and being exposed.

17. The decoration film as claimed in claim 1, wherein the substrate has a pattern structure, and the releasing layer is conformed to the pattern structure so as to have a bumpy surface.

18. The decoration film as claimed in claim 1, wherein a material of the substrate is selected from the group consisting of polyethylene terephthalate (PET), polyethylene naphthalate (PEN), polyethylene glycol-co-cyclohexane-1,4 dimethanol terephthalate (PETG), thermalplastic polyurethane (TPU), polyurethane (PU), polypropylene (PP), polycarbonate (PC), amorphous polyethylene terephthalate (A-PET), polyvinyl chloride (PVC), Polystyrene (PS), triacetyl cellulose (TAC), polymethylmethacrylate (PMMA), methylmethacrylate-styrene (MMA-st, MS) copolymer,cyclo olefin copolymer (COC) and combinations thereof.

19. The decoration film as claimed in claim 1, wherein the alignment mark includes an icon, a symbol, a letter, a figure or combinations thereof.

20. The decoration film as claimed in claim 1, further comprises at least a sub-alignment mark, disposed on the surface of the substrate, the side of the releasing layer far from the substrate or the pattern layer.

21. The decoration film as claimed in claim 2, further comprises at least a sub-alignment mark, disposed on the surface of the substrate, the side of the releasing layer far from the substrate, the matte layer or the pattern layer.

22. The decoration film as claimed in claim 11, further comprises at least a sub-alignment mark, disposed on the surface of the substrate, the side of the releasing layer far from the substrate, the protective layer or the pattern layer.

23. The decoration film as claimed in claim 12, further comprises at least a sub-alignment mark, disposed on the surface of the substrate, the side of the releasing layer far from the substrate, the metal layer, the protective layer or the pattern layer.

24. The decoration film as claimed in claim 15, further comprises at least a sub-alignment mark, disposed on the surface of the substrate, the side of the releasing layer far from the substrate, the metal layer or the pattern layer.
